(19) United States
(12) Patent Application Publication
(10) Pub. No.: US 2011/0188141 A1
(43) Pub. Date: Aug. 4, 2011

(54) DATA BACK-UP METHOD AND APPARATUS USING THE SAME

(75) Inventor: Jae-Ik SONG, Suwon-si (KR)

(73) Assignee: Samsung Electronics Co., Ltd., Suwon-si (KR)

(21) Appl. No.: 13/015,080

(22) Filed: Jan. 27, 2011

(30) Foreign Application Priority Data
Jan. 29, 2010 (KR) 2010-0008289

(51) Int. Cl. G11B 5/86

(52) U.S. Cl. 360/15; G9B/5.308

(57) ABSTRACT

A hard disk controller includes a track counter which counts the number of times each of a plurality of tracks included in each of a plurality of disks is accessed and a processing unit which compares each of a plurality of count values obtained by the counting performed by the track counter with an access reference value, and backs up data recorded on at least one of the plurality of tracks. The at least one track has a count value equal to or greater than the access reference value from among the plurality of count values.

### CROSS-REFERENCE TO RELATED APPLICATIONS

This application claims the benefit of priority under 35 U.S.C. §119 to Korean Patent Application No. 10-2010-0008289, filed on Jan. 29, 2010, in the Korean Intellectual Property Office, the disclosure of which is incorporated herein in its entirety by reference.

### BACKGROUND

1. Field of the Invention

Example embodiments relate to data backup technology, and more particularly, to a data backup method of efficiently backing up data that is frequently accessed, and apparatuses capable of performing the data backup method.

2. Description of the Related Art

With development of information technology such as information processing or information communication, previous written or edited information needs to be reused, and thus information accumulation technology becomes important. Information recording apparatuses that use various recording media such as magnetic tapes or magnetic disks have been developed and widely used.

The hard disk drive (HDD) used as an information recording apparatus is an auxiliary memory that uses a magnetic recording method. A magnetic recording medium installed in the HDD is rotated at a high speed by a motor. The HDD writes data to or reads data from a magnetic recording medium by using a magnetic head located over a surface of the rotating magnetic recording medium. The HDD backs up data stored in the magnetic recording medium in a specific region of the magnetic recording medium in order to more safely keep the data.

### SUMMARY

The present general inventive concept provides a data backup method of efficiently backing up data which is frequently accessed, a hard disk drive (HDD) capable of performing the data backup method, and a computer system including the HDD.

Additional aspects and utilities of the present general inventive concept will be set forth in part in the description which follows and, in part, will be obvious from the description, or may be learned by practice of the present general inventive concept.

Features and/or utilities of the present general inventive concept may be realized by a hard disk controller including a track counter which counts the number of times each of a plurality of tracks included in each of a plurality of disks is accessed, and a processing unit which compares each of a plurality of count values obtained by the counting performed by the track counter with an access reference value, and backs up data recorded on at least one of the plurality of tracks. The at least one track has a count value equal to or greater than the access reference value from among the plurality of count values.

The processing unit may back up the data recorded on the at least one track in one of the plurality of tracks. In another embodiment, the processing unit may divide data recorded on the at least one track into a plurality of partial data and backs up the plurality of partial data in the plurality of tracks, respectively.

Features and/or utilities of the present general inventive concept may also be realized by a data backup method performed by a hard disk controller, the method including counting the number of times each of a plurality of tracks included in each of a plurality of disks is accessed, comparing each of a plurality of count values corresponding to a result of the counting with an access reference value, and backing up data recorded on at least one of the plurality of tracks. The at least one track has a count value equal to or greater than the access reference value from among the plurality of count values.

The backing up of the data may include backing up the data recorded on the at least one track in at least one of the plurality of tracks. In another embodiment, the backing up of the data may include dividing the data recorded on the at least one track into a plurality of partial data and backs up the plurality of partial data in the plurality of tracks, respectively.

Features and/or utilities of the present general inventive concept may also be realized by a data backup method performed by a hard disk controller, the method including counting the number of times each of a plurality of tracks included in each of a plurality of disks is accessed, comparing each of a plurality of count values corresponding to a result of the counting with an access reference value, determining at least one of the plurality of tracks, the at least one track having a count value equal to or greater than the access reference value from among the plurality of count values, to be an often-accessed track and adding the often-accessed track to a backup list, determining whether the number of often-accessed units added to the backup list is equal to or greater than a track reference value, and backing up data recorded on each of the often-accessed tracks included in the backup list if the number of often-accessed units added to the backup list is equal to or greater than the track reference value.

The data backup method may further include initializing the number of each of the often-accessed tracks is accessed; and deleting the backup list.

The backing up of the data may include backing up the data recorded on each of the often-accessed tracks in each of the plurality of tracks. In another embodiment, the backing up of the data may include dividing the data recorded on each of the often-accessed tracks into a plurality of partial data and backing up the plurality of partial data in the plurality of tracks, respectively.

Features and/or utilities of the present general inventive concept may also be realized by a hard disk drive including a disk, a head which accesses the disk, and a main control unit which controls an access operation of the head, counts the number of times each of a plurality of tracks included in the disk is accessed, compares each of a plurality of count values obtained by the counting with an access reference value, and backs up data recorded on at least one of the plurality of tracks, the at least one track having a count value equal to or greater than the access reference value from among the plurality of count values.

The main control unit may back up the data recorded on the at least one track in one of the plurality of tracks. In another embodiment, the main control unit may divide the data recorded on the at least one track into a plurality of partial data and backs up the plurality of partial data in the plurality of tracks, respectively.

Features and/or utilities of the present general inventive concept may also be realized by a computer system including the above-described hard disk drive and a host which controls an operation of the hard disk drive.

Features and/or utilities of the present general inventive concept may also be realized by a hard disk drive including a disk having a plurality of tracks to store data, and a controller to count a number of times each of the plurality of tracks is accessed, to identify often-accessed tracks of the plurality of tracks by comparing the number of times each of the plurality of tracks is accessed to a reference number greater than 1, and to back up data on each often-accessed track of the plurality of tracks, the often-accessed track being a track that is accessed at least a number of times equal to the reference number.

When the controller determines that a track of the plurality of tracks is an often-accessed track, the controller may save identifying information of the track to a list of often-accessed tracks, and the controller may back up data of each of the often-accessed tracks only after the list of often-accessed tracks may include at least a predetermined number of tracks greater than 1.

The controller may delete the list after backing up the often-accessed tracks.

The controller may reset to zero a count corresponding to a number of times each of the often-accessed tracks has been accessed after the controller backs up the data from the respective often-accessed track.

The controller may count the number of times each of the plurality of tracks is accessed within a predetermined period of time and re-sets the count at the end of each predetermined period of time.

The controller may back up the data from the often-accessed tracks onto unused tracks of the plurality of tracks, and, after backing up the data onto the unused tracks, the controller may designate the previously-unused tracks as back-up tracks.

Features and/or utilities of the present general inventive concept may also be realized by a method of backing up data including counting a number of times that a track of a disk is accessed, comparing the counted number of times to a first reference number greater than 1, and backing up data from the track when the counted number of times is at least equal to the reference number.

The disk may include a plurality of tracks, and backing up the data may include saving identification data of the track to a list and backing up the data from the track only when a number of tracks on the list is at least equal to a second reference number greater than 1.

The method may further include deleting the identification data on the list after backing up the data. The method may further include re-setting to zero the counted number after backing up the data.

The number of times that the track is accessed may be counted within a predetermined period of time, and the counted number is re-set after the predetermined period of time.

The predetermined period of time may include at least an oldest sub-period and a more-recent sub-period, resetting the counted number may include resetting the counted number omit a counted number of the oldest sub-period.

### BRIEF DESCRIPTION OF THE DRAWINGS

The above and/or other aspects of the present general inventive concept will become apparent and more readily appreciated from the following description of the exemplary embodiments, taken in conjunction with the accompanying drawings, in which:

FIG. 1 is a schematic block diagram of a hard disk drive (HDD) according to an embodiment of the present general inventive concept;

FIG. 2 is a schematic block diagram of a hard disk controller illustrated in FIG. 1;

FIG. 3A is a flowchart of a data backup method according to an embodiment of the present general inventive concept;

FIG. 3B is a flowchart of a data backup method according to another embodiment of the present general inventive concept;

FIG. 4 is a flowchart of a data backup method according to an another embodiment of the present general inventive concept;

FIG. 5 is a schematic block diagram of a computer system including an HDD, according to an embodiment of the present general inventive concept;

FIG. 6A illustrates data access of tracks of a disk during predetermined periods of time;

FIG. 6B illustrates tracking the number of times that each track is accessed within predetermined periods of time;

FIGS. 7A to 7C illustrate registers to count the number of times a track is accessed; and

FIGS. 8A and 8B illustrate resetting a count of the number of times a track is accessed.

### DETAILED DESCRIPTION OF THE EMBODIMENTS

Detailed example embodiments are disclosed herein in order to explain the present general inventive concept by referring to the figures. However, specific structural and functional details disclosed herein are merely representative for purposes of describing example embodiments. Example embodiments may be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

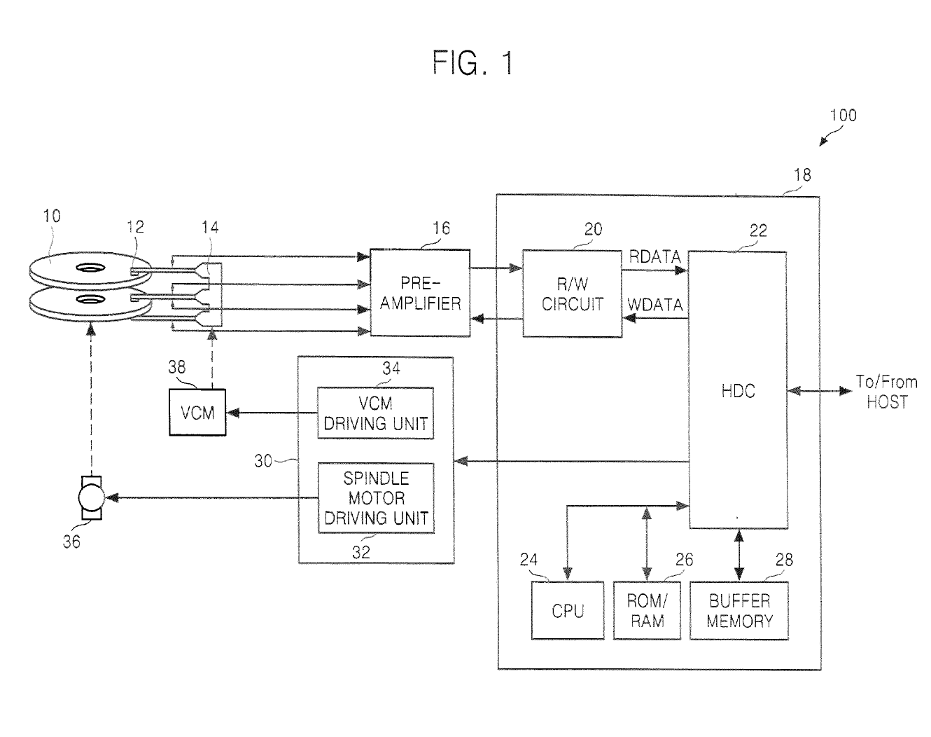

FIG. 1 is a schematic block diagram of a hard disk drive (HDD) 100 according to an embodiment of the present general inventive concept. Referring to FIG. 1, the HDD 100, which is used as a data storage device, includes a plurality of disks 10, a plurality of heads 12, a head assembly 14, a pre-amplifier 16, a main control unit (MCU) 18, a motor control unit (or a servo control unit) 30, a spindle motor 36, and a voice coil motor (VCM) 38.

Each of the disks 10 may store data output from a host (not shown), and is rotated by the spindle motor 36. Each of the heads 12 is located over a corresponding disk 10 from among the disks 10 to perform a read operation or a write operation, and is installed on each of a plurality of support arms extending from the head assembly 14 coupled with the VCM 38 toward the disks 10.

When data stored in one of the disks 10, which are magnetic recording media, is read, the pre-amplifier 16 amplifies an analog read signal output from one of the heads 12 and outputs an amplified analog read signal to a read/write channel circuit 20 (hereinafter, referred to as an R/W circuit 20). When data is written to in one of the disks 10, which are magnetic recording media, the pre-amplifier 16 transmits a write signal, for example, a write current, output from the R/W circuit 20 to one of the heads 12. Accordingly, the head may write data corresponding to the write signal to one of the disks 10.

The R/W circuit 20 converts the amplified analog read signal obtained by the pre-amplifier 16 into read data RDATA and outputs the read data RDATA to a hard disc controller (HDC) 22. The HDC 22 may perform error correction on the read data RDATA. The R/W circuit 20 also converts write data WDATA received from the HDC 22 into the write signal and outputs the write signal to the pre-amplifier 16.

When data is written to a disk 10, the HDC 22 outputs write data received from the host to the R/W circuit 20 under the control of the CPU 24. Accordingly, the write data output from the host may be written to one of the disks 10 via the R/W circuit 20, the pre-amplifier 16, and one of the heads 12. When data is read from a disk 10, the HDC 22 may receive the read data RDATA decoded by the R/W circuit 20, perform error correction on the received read data RDATA, and transmit error-corrected data, which is a result of the error correction, to the host via an interface, under the control of the CPU 24.

The HDC 22 counts the number of times each of a plurality of tracks included in the disks 10 is accessed. For example, when the counted number of times one of the tracks is accessed is equal to or greater than a pre-stored reference value, data stored on the track is separately stored on another track from among the tracks, so that the data is backed up. The reference value may be greater than 1.

The HDC 22 may maintain a counter for a predetermined period of time. For example, the HDC 22 may determine whether a particular track is accessed 3 or more times within a 1 day period of time. Accordingly, the tracks that are accessed the most often may be backed up, and the tracks that are accessed only occasionally may not be backed up by the HDC 22.

The CPU 24 may read a control code or a boot code from a read only memory (ROM) 26, store the read control code in a random access memory (RAM) 26, and entirely control an operation of the HDD 100 or the HDC 22 by using codes stored in the RAM 26. Accordingly, the CPU 24 may not only control a read operation or write operation of the HDD 100 but also control a backup operation according to an embodiment of the present general inventive concept.

Although the ROM 26 and the RAM 26 is illustrated as one memory in FIG. 1 for convenience of explanation, the ROM 26 and the RAM 26 may be physically-separate memory devices.

The CPU 24 may receive a read command or a write command from the host and control an operation of a servo controller (not shown), which controls a spindle motor driving unit 32 and a VCM driving unit 34, in order to control a track seek or track following according to the received read or write command. The spindle motor driving unit 32 controls an operation of the spindle motor 36, which controls rotations of the disks 10, in response to a control signal output from a servo controller of the HDC 22.

The VCM driving unit 34 generates a driving current for driving the VCM 38, in response to a control signal for controlling the locations of the heads 12, the control signal output from the servo controller, and outputs the driving current to a voice coil of the VCM 38. Accordingly, the VCM 38 moves one of the heads 12 to locations over the tracks of a disk 10 having recorded thereon data to be read from among the disks 10, according to the direction and level of the driving current output from the VCM driving unit 34. The head 12 moved by the VCM 38 outputs location information recorded on the disk 10 to the pre-amplifier 16 on the basis of the control signal output from the R/W circuit 20.

When the head 12 is moved to a target track of the disk 10 from which data is to be read, a disk formatter (not shown) of the HDC 22 outputs a servo gate signal to the R/W circuit 20. The R/W circuit 20 reads a servo pattern from the disk 10 in response to the servo gate signal. The buffer memory 28 may temporarily store data that is communicated between the HDD 100 and the host. In some embodiments, the buffer memory 28 may be embodied outside the MCU 18.

In some embodiments, the MCU 18 including the R/W circuit 20, the HDC 22, the CPU 24, the ROM/RAM 26, and the buffer memory 28 may be implemented into a single chip, for example, a System on Chip (SoC). The motor control unit 30 including the spindle motor driving unit 32 and the VCM driving unit 34 may be implemented into a single chip, for example, an SoC.

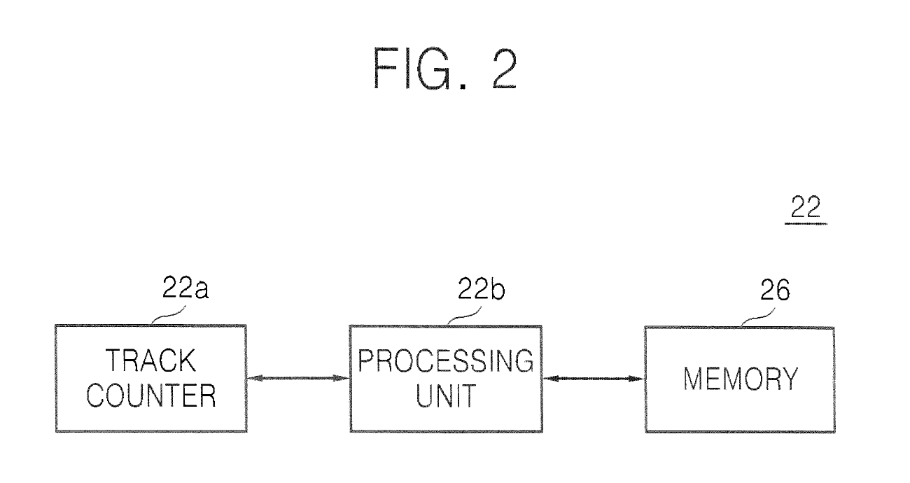

FIG. 2 is a schematic block diagram of the HDC 22 illustrated in FIG. 1. Referring to FIG. 2, the HDC 22 includes a track counter 22a, a memory 26, and a processing unit 22b. The track counter 22a counts the number of times each of a plurality of tracks included in each of the disks 10 is accessed. The track counter 22a outputs the counted numbers of times the tracks of the disks 10 are accessed, for example, a plurality of count values, to the processing unit 22b.

Various types of data required to operate the HDC 22 are stored in the memory 26. The memory 26 stores an access reference value. The access reference value may be compared with each of the numbers of times the tracks of the disks 10 are accessed, the numbers of times counted by the track counter 22a, (for example, the count values). The memory 26 stores an access list generated by the processing unit 22b. The memory 26 may store a backup list including tracks accessed a number of times equal to or greater than the access reference value, under the control of the processing unit 22b. At this time, the memory 26 previously stores a track reference value so that the processing unit 22b may compare the number of tracks included in the backup list with the track reference value.

Although the memory 26 is included in the HDC 22 in FIG. 2, the memory 26 may be embodied as a part of the ROM/RAM 26 of FIG. 1 outside the HDC 22.

The processing unit 22b controls the entire operation of the HDC 22. The processing unit 22b compares each of the numbers of times the tracks of the disks 10 are accessed, the numbers of times counted by the track counter 22a, with the access reference value. The processing unit 22b determines what track stores data which is to be backed up, according to a result of the comparison between each of the numbers of times the tracks of the disks 10 are accessed and the access reference value. For example, if the number of times a specific track from among the tracks is accessed is equal to or greater than the access reference value, the processing unit 22b determines that data recorded on the specific track is backed up. On the other hand, if the number of times the specific track from among the tracks is accessed is less than the access reference value, the processing unit 22b determines that data recorded on the specific track is not backed up.

The processing unit 22b may generate an access list in which the number of times each of the tracks included in the disks 10 is accessed is recorded, or a backup list including only tracks to be accessed a number of times equal to or greater than the access reference value, and store the access list or the backup list in the memory 26. The processing unit 22b manages each of the tracks included in the disks 10 by using the access list or the backup list. The processing unit 22b controls the operation of the HDD 100 so that data recorded in tracks accessed a number of times equal to or greater than the access reference value is backed up in one of the tracks included in the disks 10 by referring to the access list.

When the number of tracks included in the backup list is equal to or greater than the track reference value, the processing unit 22b backs up the data recorded in the tracks included in the backup list. Accordingly, the processing unit 22b may back up the data recorded on tracks frequently accessed, all at once.

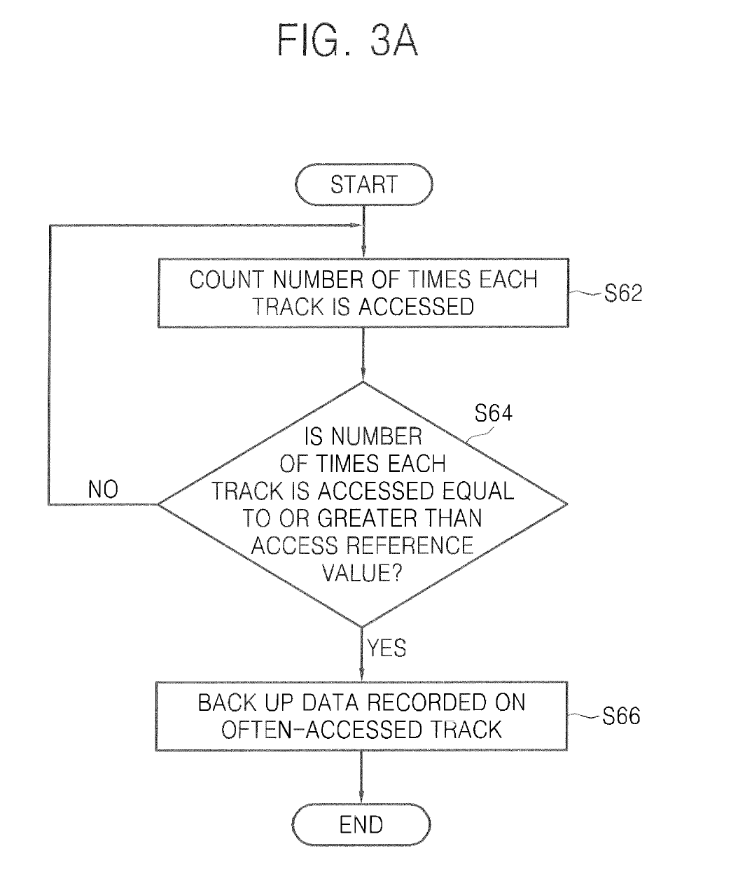

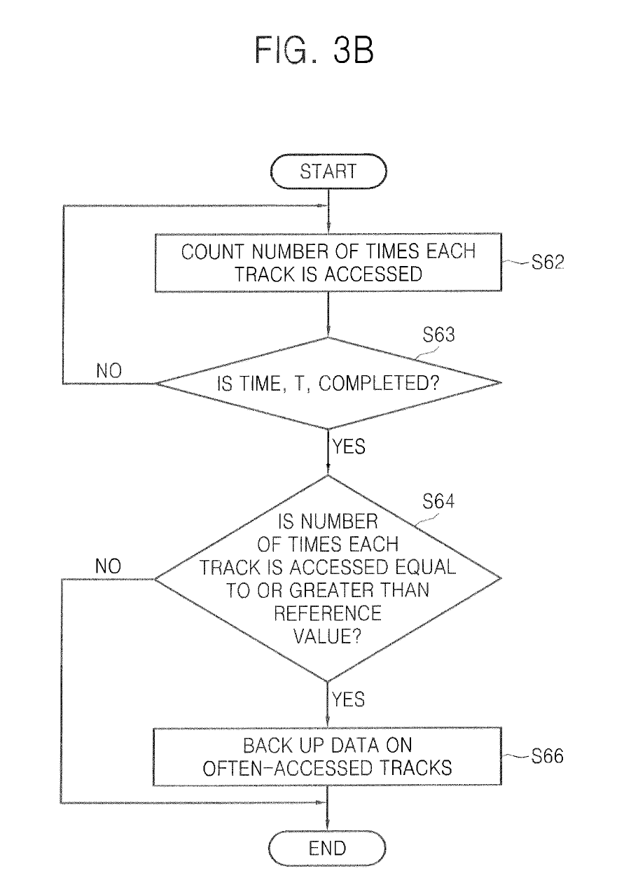

FIG. 3A is a flowchart of a data backup method according to an embodiment of the present general inventive concept. In operation S62, the track counter 22a of the HDC 22 counts the number of times each of a plurality of tracks included in each of the disks 10 is accessed. The counted number of times each of the tracks of the disks 10 is accessed, for example, a count value, is output to the processing unit 22b. The processing unit 22b may manage each of the tracks accessed, by generating an access list for the tracks accessed.

The access list includes N entries when the total number of tracks included in the disks 10 is N. It is assumed in FIG. 3 that the access list constitutes the number of tracks and the number of entries at a ratio of 1:1. The access list may constitute the number of tracks and the number of entries at a ratio of 1:M (where M denotes a natural number), according to the resource of the HDD 100, for example, the capacity of a buffer memory region or a non-volatile memory region of the HDD 100. In other words, a plurality of entries may correspond to a single track. Conversely, one entry may correspond to a block of multiple tracks, and all of the tracks of the block may be backed up when any of the tracks in the block is accessed a predetermined number of times.

In operation S64, the processing unit 22b determines whether each of the numbers of times the tracks of the disks 10 are accessed is equal to or greater than the access reference value.

If each of the numbers of times the tracks of the disks 10 are accessed is less than the access reference value, the processing unit 22b controls the track counter 22a to resume the operation S62 of counting the numbers of times the tracks of the disks 10 are accessed. At this time, the processing unit 22b may continuously update the access list according to the numbers of times the tracks of the disks 10 are accessed. Accordingly, the processing unit 22b may ascertain the numbers of times the tracks of the disks 10 are accessed. Thus, the processing unit 22b may easily ascertain frequently accessed tracks or infrequently accessed tracks.

If at least one of the tracks is accessed a number of times equal to or greater than the access reference value, the processing unit 22b backs up the data recorded on the at least one track accessed a number of times equal to or greater than the access reference value (hereinafter, referred to as an often-accessed track), in operation S66.

When the often-accessed track is generated, the processing unit 22b may back up the data recorded on the often-accessed track by recording the data on another track from among the tracks included in the disks 10. The track on which the data recorded on the often-accessed track is backed up (hereinafter, referred to as a backup track) may be determined by the processing unit 22b. In some embodiments, the processing unit 22b may determine the backup track according to the data stored in the memory 26.

In some embodiments, the processing unit 22b may divide the data recorded on an often-accessed track into a plurality of partial data and record the partial data on a plurality of backup tracks, respectively. For example, the processing unit 22b may divide the data recorded on an often-accessed track into 5 partial data and record the 5 partial data on 5 backup tracks, respectively. If the data of the often-accessed track is divided into a plurality of partial data and each of the partial data is recorded on at least one of a plurality of backup tracks, the processing unit 22b may record head data and tail data included in the data of the often-accessed track together with each of the partial data on at least one of the plurality of backup tracks.

Afterward, when the HDD 100 uses partial data recorded on each of the plurality of backup tracks, if head data and tail data recorded in each of the backup tracks do not match with partial data recorded in each of a plurality of often-accessed tracks, the processing unit 22b may restrict the use of the partial data.

Every time power is supplied to the HDD 100, the HDC 22 may perform a data backup operation as described above with reference to FIG. 3. When power is supplied to the HDD 100, the processing unit 22b of the HDC 22 may determine whether data recorded in each of the tracks included in the disks 10 is effective, by verifying the effectiveness of a region (for example, a track) frequently accessed from among the tracks. If it is determined that the data is not effective, the processing unit 22b may recover the ineffective data by using the data backed up in each of the plurality of backup tracks.

FIG. 3B is a flowchart of a data backup method according to another embodiment of the present general inventive concept. As illustrated in FIG. 3B, the hard disc controller 22 may determine a number of times each track is accessed within a predetermined period of time, T. As discussed above in FIG. 3A, the HDC 22 may count the number of times a track is accessed in operation S62. In operation S63, the HDC 22 determines whether the time period, T, is completed. If not, the HDC 22 continues counting the number of times each track is accessed. If the time, T, is completed, the HDC 22 determines whether any track has been accessed a number of times equal to or greater than a reference value in operation S64. If so, the data from the often-accessed tracks is backed up in operation S66. Otherwise, the process ends and may be repeated any number of times or for any desired duration of time. For example, the process may continually run as long as the hard disk drive 100 is operational.

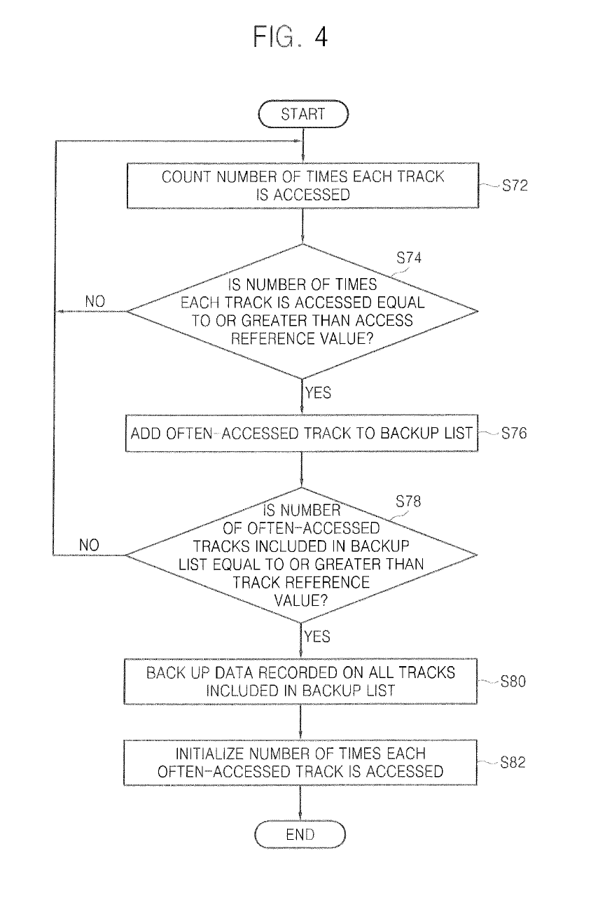

FIG. 4 is a flowchart of a data backup method according to another embodiment of the present general inventive concept. In operation S72, the track counter 22a of the HDC 22 counts the number of times each of a plurality of tracks included in each of the disks 10 is accessed. Every time at least one track is accessed, the track counter 22a increases the number of times the at least one track is accessed, under the control of the processing unit 22b. The processing unit 22b may make an access list including the numbers of times the tracks of the disks 10 are accessed, the numbers of times output from the track counter 22a. Table 1 shows an example of the access list.

TABLE 1

| Track | Number of times track is accessed |
|---|---|
| 1^{st} track | 3 |
| 2^{nd} track | 0 |
| 3^{rd} track | 1 |
| 4^{th} track | 4 |
| 5^{th} track | 6 |
| 6^{th} track | 12 |
| 7^{th} track | 22 |
| 8^{th} track | 10 |
| 9^{th} track | 0 |
| 10^{th} track | 8 |
| 11^{th} track | 25 |
| 12^{th} track | 0 |
| . . . | . . . |

Referring to Table 1, since the numbers of times a second track, a ninth track, and a twelfth track are accessed are 0, the second track, the ninth track, and the twelfth track have not been accessed. The second track, the ninth track, and the twelfth track may be tracks in which no data is not recorded (hereinafter, referred to as blank (or empty) tracks). If the access reference value used to determine whether a track is an often-accessed track is 20, a seventh track and an eleventh track are often-accessed tracks because the numbers of times the seventh track and the eleventh track are accessed are respectively 22 and 25.

Although the number of times a track is accessed is expressed as a decimal number in Table 1, the track counter 22a may set the initial value of the number of access times to be 0xff, which is a hexadecimal number, and increase the number of access times by 1 every time the track is accessed.

In operation S74, the processing unit 22b determines whether each of the numbers of times the tracks of the disks 10 are accessed, the numbers of times counted by the track counter 22a, is equal to or greater than the access reference value. If each of the plurality of numbers of times the tracks of the disks 10 are accessed is less than the access reference value, the processing unit 22b controls the track counter 22a to resume the operation S72 of counting the numbers of times the tracks of the disks 10 are accessed. On the other hand, if at least one of the tracks is accessed a number of times equal to or greater than the access reference value, the processing unit 22b determines the at least one track accessed a number of times equal to or greater than the access reference value to be an often-accessed track and in operation S76 adds the often-accessed track to the backup list. Table 2 shows an example of the backup list.

TABLE 2

| No. | Track | Number of times track is accessed |
|---|---|---|
| 1 | 7^{th} track | 22 |
| 2 | 11^{th} track | 25 |
| 3 | 18^{th} track | 20 |
| 4 | 22^{th} track | 28 |
| 5 | 35^{th} track | 31 |
| . . . | . . . | . . . |

Referring to Table 2, the numbers of times a seventh track, an eleventh track, an eighteenth track, a twenty second track, and a thirty fifth track are accessed are 22, 25, 20, 28, and 31, respectively. The processing unit 22b may determine or calculate the number of often-accessed tracks from the backup list, and may also determine or calculate the number of times each of the often-accessed tracks is accessed.

In operation S78, the processing unit 22b determines whether the number of often-accessed tracks included in the backup list is equal to or greater than the track reference value. The track reference value may be stored in the memory 26.

If the number of often-accessed tracks included in the backup list is less than the track reference value, the processing unit 22b controls the track counter 22a to resume the operation S72 of counting the numbers of times the tracks of the disks 10 are accessed. On the other hand, if the number of often-accessed tracks included in the backup list is equal to or greater than the track reference value, the processing unit 22b in operation S80 backs up the data recorded in each of the tracks included in the backup list.

For example, if the track reference value is 5, the processing unit 22b determines whether the number of often-accessed tracks included in the backup list is equal to or greater than 5. Referring to the backup list of Table 2, since the seventh track, the eleventh track, the eighteenth track, the twenty-second track, and the thirty-fifth track are often-accessed tracks and the number of often-accessed tracks is 5, the number of often-accessed tracks is equal to or greater than the track reference value. Accordingly, the processing unit 22b controls the HDD 100 to back up the data recorded in each of the seventh track, the eleventh track, the eighteenth track, the twenty-second track, and the thirty-fifth track. At this time, the processing unit 22b may back up the data recorded in each of the often-accessed tracks in each of blank tracks, where no data is recorded, like the second track, the ninth track, and the twelfth track of Table 1. When the data recorded in the often-accessed tracks is backed up onto the blank tracks, the blank tracks may be designated by the hard disk controller 22 as back-up tracks to prevent normal write operations other than the back-up operations from accessing the previously-blank tracks. Alternatively, the often-accessed tracks may be backed up onto portions of the disks 10 that are set aside as back up portions during an initial configuration of the hard disk drive 100 before normal read/write operations are performed to write data to and read data from the disks 10.

Once the data recorded in each of the often-accessed tracks included in the backup list is backed up, the processing unit 22b in operation S82 initializes the number of times each of the often-accessed tracks is accessed. At this time, the processing unit 22b may delete the backup list including the often-accessed tracks. The processing unit 22b may control the HDD 100 to repeat the operations S72 through to S82 again. Thus, the HDD 100 may easily back up the data recorded in at least one track that is frequently accessed.

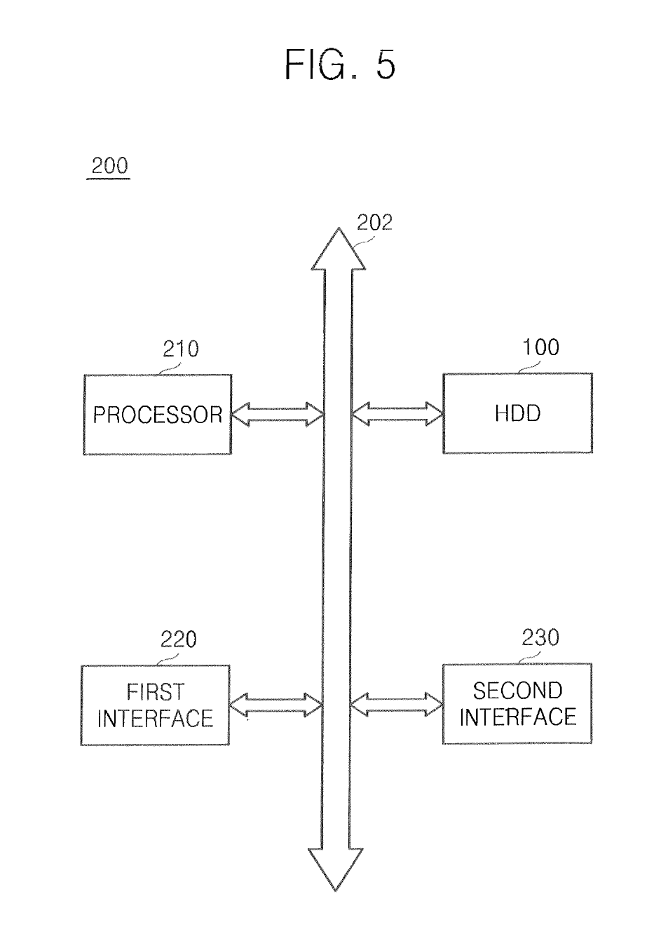

FIG. 5 is a schematic block diagram of a computer system 200 including the HDD 100 of FIG. 1, according to an embodiment of the present general inventive concept. Referring to FIG. 5, the computer system 200 is any data storage device using a magnetic recording medium, such as a PC, a note-book, a net-book, a tablet PC, a portable computer, a handheld communication device, a digital TV, or a home automation device.

Referring to FIG. 5, the computer system 200 includes the HDD 100 and a processor 210 which are connected to each other via a system bus 202. The processor 210 may function as the host of the HDD 100 and may control the entire operation of the HDD 100, for example, a read operation or write operation.

As described above with reference to FIGS. 1 through 4, the HDD 100 counts the number of times each of a plurality of tracks included in the disks 10 is accessed, and backs up the data recorded in at least one track accessed a number of times equal to or greater than an access reference value. The computer system 200 may further include a first interface 220. The first interface 220 may be an input/output interface. For example, the first interface 220 may be an output device such as a monitor or a printer, or an input device such as a touch screen, a mouse, or a keyboard.

The computer system 200 may further include a second interface 230. The second interface 230 may be a wireless communication interface capable of performing wireless communication with an external computer system. The second interface 230 may wirelessly transmit the data stored in the HDD 100 to the external computer system or store data received from the external computer system in the HDD 100, under the control of the processor 210. In some embodiments, if the computer system 200 is a hybrid HDD, the computer system 200 may further include a non-volatile memory device. The processor 210 may store data in the HDD 100 or the non-volatile memory device according to a data storage policy.

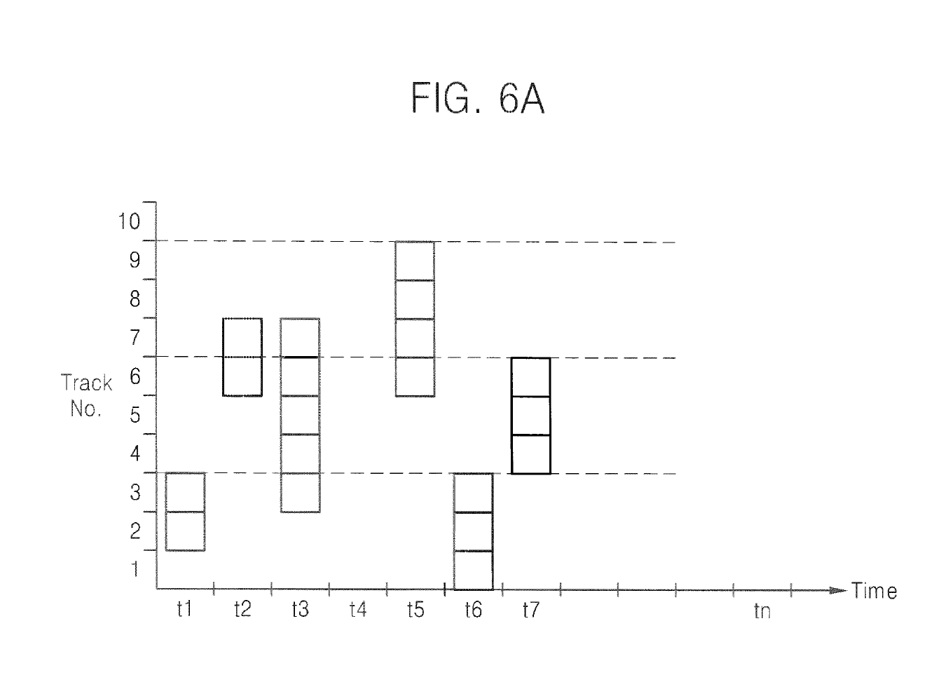

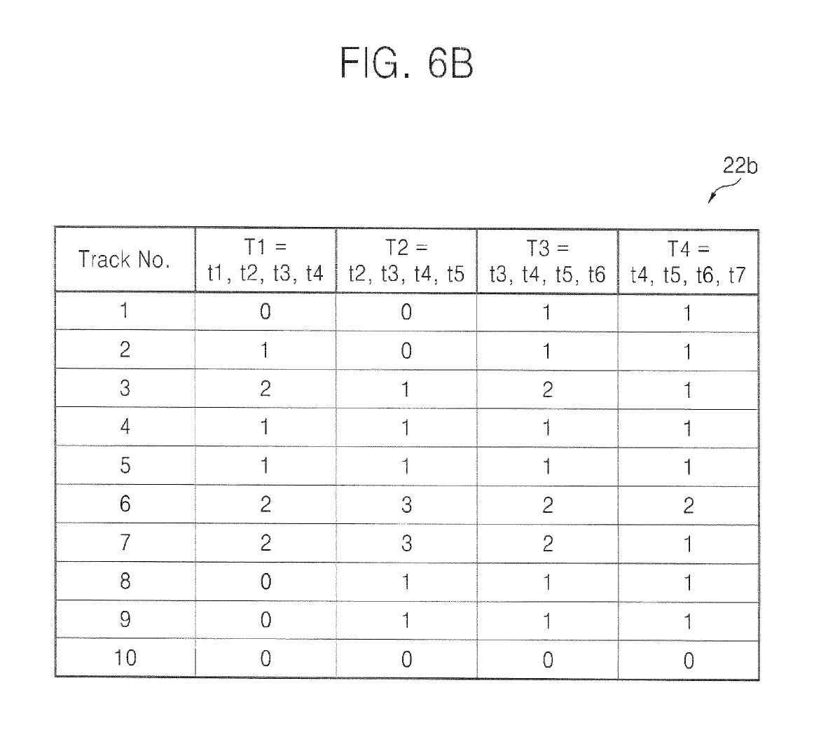

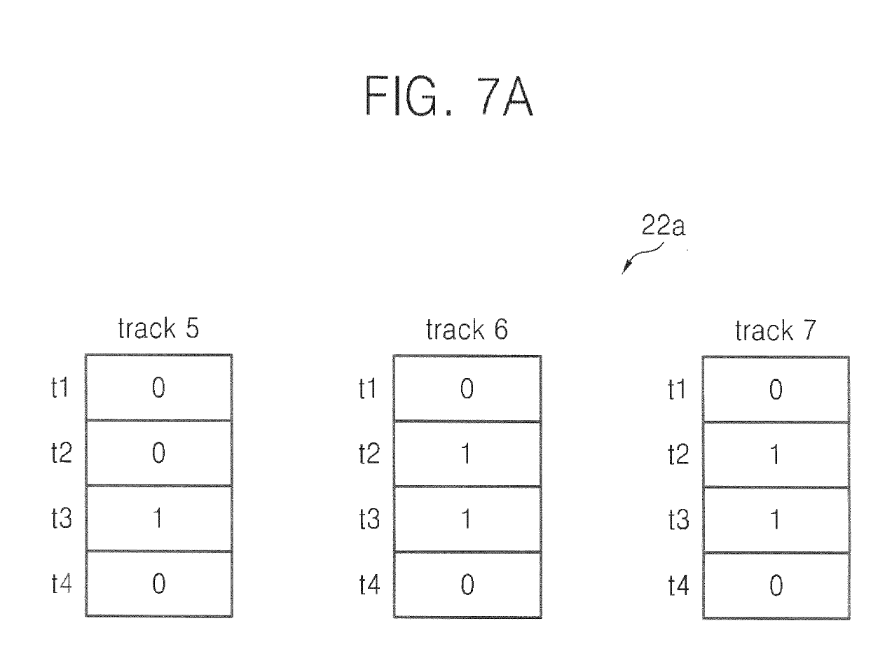

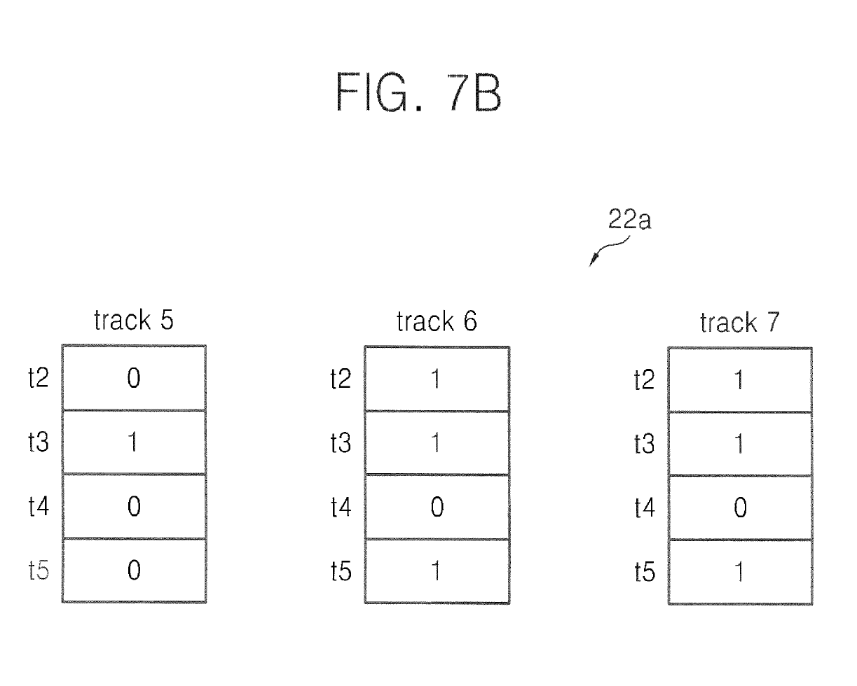

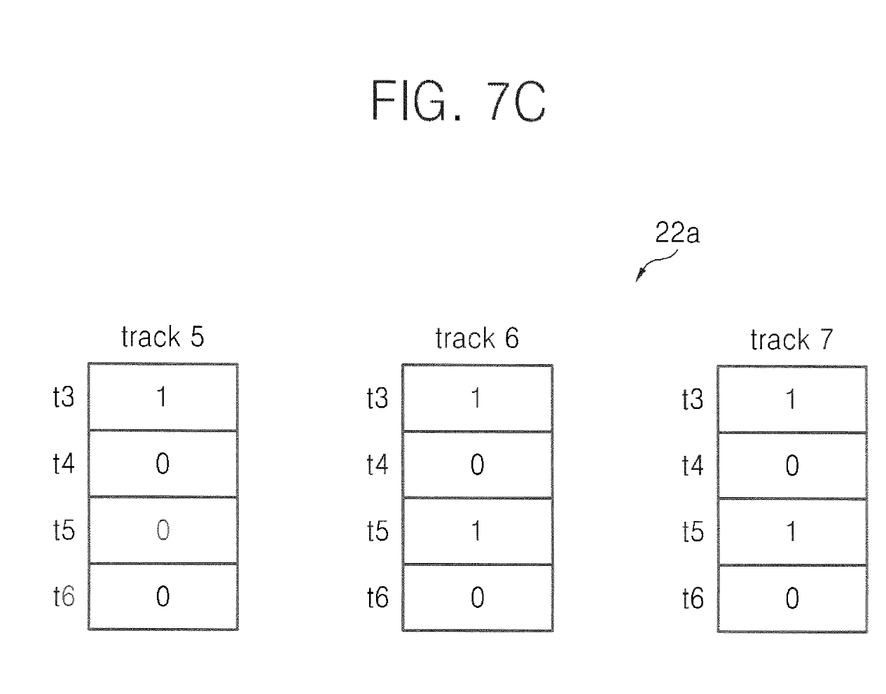

FIGS. 6A to 8B illustrate further examples of embodiments of the present general inventive concept. FIGS. 6A, 6B, and 7A to 7C illustrate an example embodiment in which the hard disk controller HDC 22 determines which tracks are often-accessed in a predetermined period of time, T. The period of time, T, is made up of sub-periods of time, t. For example, if the period of time T is one hour, each sub-period of time, t, may correspond to a 15-minute interval. FIG. 6A illustrates an example of a disk having 10 tracks, and the number of times that each track is accessed in each given period of time, t. For example, in period of time, t1, only tracks 2 and 3 are accessed. In period t2, only tracks 6 and 7 are accessed.

FIG. 6B illustrates an example of data stored in the HDC 22, such as in the processing unit 22b. For each period of time T, the processing unit 22b may calculate the total number of times that each track is accessed in the corresponding periods of time, t. For example, the period of time T1 corresponds to the sub-periods t1, t2, t3, and t4. If the HDC 22 is configured to back up a track when it is accessed at least 3 times in a period of time, T, then no track is backed up after the period of time T1. However, in period T2, which is made up of sub-periods t2, t3, t4, and t5, tracks 6 and 7 are each accessed 3 times. Accordingly, the hard disk controller 22 may control the R/W circuit 16 to back up tracks 6 and 7. The HDC 22 may continue the process for each subsequent period of time T3, T4 . . . Tn.

FIGS. 7A to 7C illustrate example embodiments of a track counter 22a according to the present embodiment. The track counter 22a may be made up of a plurality of stacks, for example registers of a memory device, and each section of the stack may correspond to a sub-period of time, t. The sum of the sections in the stack may correspond to the period of time, T. FIG. 7A illustrates stacks corresponding to tracks 5, 6, and 7 and the first time period T1. After it is determined that the time period t4 has ended, the stack may be shifted, so that the data corresponding to the new sub-period t5 is stored in the bottom memory section of the stack, and the data corresponding to the sub-period t2 is stored in the top-most memory section of the stack. As described above, the contents of the stacks may be transmitted to the processing unit 22b which determines that the values stored in the stacks corresponding to tracks 6 and 7 equal the predetermined value. Accordingly, the HDC 22 may back up the data of tracks 6 and 7.

In FIG. 7C, after the sub-period t5 is ended, the count corresponding to the next time period t6 is stored in the bottom-most memory section of each stack, and the count corresponding to the sub-period t3 is shifted to the top-most memory section of each stack. Accordingly, the track counter 22a may continually track the track count of each track corresponding to each sub-period t and each time period T, and may transmit the track count to the processing unit 22b.

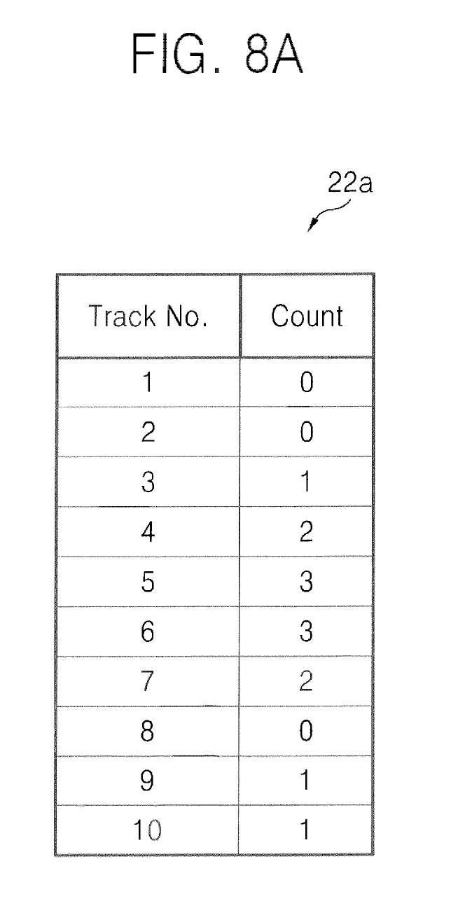

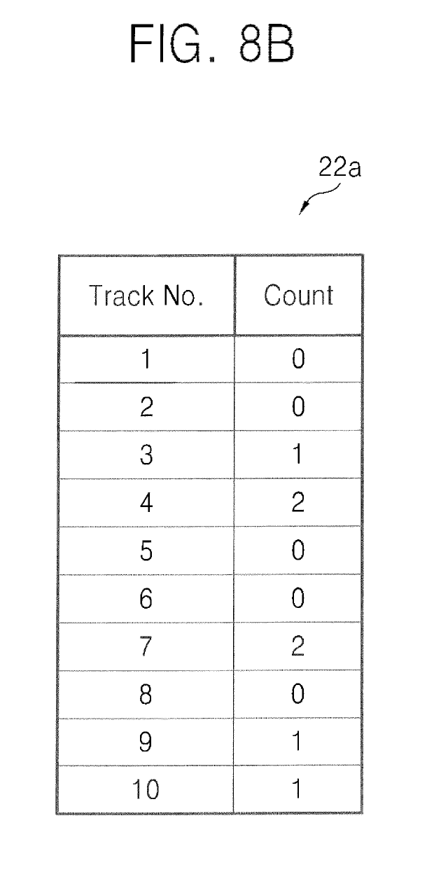

FIGS. 8A and 8B illustrate yet another embodiment similar to that described with respect to FIG. 4 and table 1, above. In FIGS. 8A and 8B, the track counter 22a may count a total number of times each track has been accessed, and may reset the track-count to zero after the data corresponding to a track has been backed up. For example, FIG. 8A illustrates tracks 5 and 6 having been accessed a total of 3 times each. If the back-up triggering reference number is 3, then the HDC 22 may control the R/W circuit 20 to back up the data of tracks 5 and 6 onto the disks 10. Subsequently, in FIG. 8B, the track-counts corresponding to tracks 5 and 6 may be reset to zero, and the track-access counting process may be repeated.

A data backup method and apparatuses capable of performing the data backup method according to an embodiment of the present general inventive concept can efficiently back up data that is frequently accessed. A data backup method and apparatuses capable of performing the data backup method according to an embodiment of the present general inventive concept can prevent frequently accessed data from being lost by unexpected situations, by backing up the data.

While the present general inventive concept has been particularly shown and described with reference to exemplary embodiments thereof, it will be understood that various changes in form and details may be made therein without departing from the spirit and scope of the following claims.

What is claimed is:

1. A hard disk controller comprising:
a track counter which counts the number of times each of a plurality of tracks included in each of a plurality of disks is accessed; and
a processing unit which compares each of a plurality of count values obtained by the counting performed by the track counter with an access reference value, and backs up data recorded on at least one of the plurality of tracks, the at least one track having a count value equal to or greater than the access reference value from among the plurality of count values.

2. The hard disk controller of claim 1, wherein the processing unit backs up the data recorded on the at least one track in one of the plurality of tracks.

3. The hard disk controller of claim 1, wherein the processing unit divides data recorded on the at least one track into a plurality of partial data and backs up the plurality of partial data in the plurality of tracks, respectively.

4. A data backup method performed by a hard disk controller, the method comprising:
counting the number of times each of a plurality of tracks included in each of a plurality of disks is accessed;
comparing each of a plurality of count values corresponding to a result of the counting with an access reference value; and
backing up data recorded on at least one of the plurality of tracks, the at least one track having a count value equal to or greater than the access reference value from among the plurality of count values.

5. The data backup method of claim 4, wherein the backing up the data comprises backing up the data recorded on the at least one track in at least one of the plurality of tracks.

6. The data backup method of claim 4, wherein the backing up the data comprises dividing the data recorded on the at least one track into a plurality of partial data and backing up the plurality of partial data in the plurality of tracks, respectively.

7. A data backup method performed by a hard disk controller, the method comprising:
counting the number of times each of a plurality of tracks included in each of a plurality of disks is accessed;
comparing each of a plurality of count values corresponding to a result of the counting with an access reference value;
determining at least one of the plurality of tracks, the at least one track having a count value equal to or greater than the access reference value from among the plurality of count values, to be an often-accessed track and adding the often-accessed track to a backup list;
determining whether the number of often-accessed tracks added to the backup list is equal to or greater than a track reference value; and
backing up data recorded on each of the often-accessed tracks included in the backup list, if the number of often-accessed tracks added to the backup list is equal to or greater than the track reference value.

8. The data backup method of claim 7, further comprising:
initializing the number of each of the often-accessed tracks is accessed; and
deleting the backup list.

9. The data backup method of claim 7, wherein the backing up the data comprises backing up the data recorded on each of the often-accessed tracks in each of the plurality of tracks.

10. The data backup method of claim 7, wherein the backing up the data comprises dividing the data recorded on each of the often-accessed tracks into a plurality of partial data and backing up the plurality of partial data in the plurality of tracks, respectively.

11. A hard disk drive comprising:
a disk;
a head which accesses the disk; and
a main control unit which controls an access operation of the head, counts the number of times each of a plurality of tracks included in the disk is accessed, compares each of a plurality of count values obtained by the counting with an access reference value, and backs up data recorded on at least one of the plurality of tracks, the at least one track having a count value equal to or greater than the access reference value from among the plurality of count values.

12. The hard disk drive of claim 11, wherein the main control unit backs up the data recorded on the at least one track in at least one of the plurality of tracks.

13. The hard disk drive of claim 11, wherein the main control unit divides the data recorded on the at least one track into a plurality of partial data and backs up the plurality of partial data in the plurality of tracks, respectively.

14. The hard disk drive of claim 11, wherein the main control unit comprises a memory which stores the access reference value.

15. The hard disk drive of claim 11, further comprising a memory which stores the access reference value.

16. A computer system comprising:
the hard disk drive; and
a host which controls an operation of the hard disk drive,
wherein the hard disk drive comprises:
a disk;
a head which accesses the disk; and
a main control unit which controls an access operation of the head, counts the number of times each of a plurality of tracks included in the disk is accessed, compares each of a plurality of count values obtained by the counting with an access reference value, and backs up data recorded on at least one of the plurality of tracks, the at least one track having a count value equal to or greater than the access reference value from among the plurality of count values.

17. The computer system of claim 16, wherein the main control unit backs up the data recorded on the at least one track in one of the plurality of tracks.

18. The computer system of claim 16, wherein the main control unit divides the data recorded on the at least one track into a plurality of partial data and backs up the plurality of partial data in the plurality of tracks, respectively.
